(19) United States
(12) Patent Application Publication
(10) Pub. No.: US 2015/0165566 A1
(43) Pub. Date: Jun. 18, 2015

(54) Adaptable Facility for Assembling Different Sheet Metal Elements

(71) Applicant: ABB Technology AG, Zurich (CH)

(72) Inventors: Bernard Negre, Paris (FR); Charles Hermann, Bouffemont (FR)

(21) Appl. No.: 14/399,906

(22) PCT Filed: May 9, 2012
(86) PCT No.: PCT/EP2012/058576

§ 371 Date: Mar. 9, 2015

(51) Int. Cl. B23K 37/047

(52) U.S. Cl. CPC B23K 37/047; Y10S 901/42

(57) ABSTRACT

An adaptable installation for assembling sheet metal parts is provided, so as to constitute sheet metal elements of a plurality of types. The installation has a series of assembly stations in a row, each station being dedicated to assembling one type of element, at least one assembly rail extending parallel to the series of stations in a row and carrying at least one assembly robot that can move from one station to another along the rail that carries it in order to assemble sheet metal parts together at each station, and at least one handling rail extending along an assembly rail and carrying at least one handling robot in order to supply each station with sheet metal parts to be assembled and in order to extract the elements that have been assembled from each station.

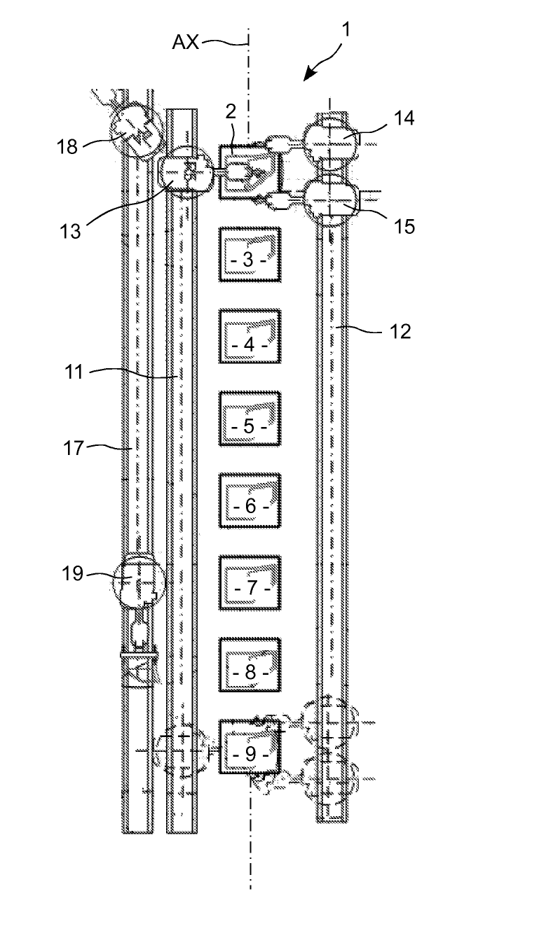

### BACKGROUND OF THE INVENTION

### Field of the Invention

The invention relates to an adaptable robotized assembly line for assembling sheet metal elements by welding (for example) various sheet metal parts to one another. The invention lies within the context of automated lines where handling and assembly are performed by robots in the form of hinged arms performing operations and movements that are coordinated and controlled by a centralized unit.

The invention relates to assembling sheet metal elements for motor vehicles such as body sides, or opening members such as hoods, side doors, or tailgates, which typically require a shell and a liner to be assembled together, e.g. by welding in order to constitute a rigid unit.

Such an installation is expected to be completely adaptable: it must make it possible to produce various types of element in any order, both for throughput rates that may be low and for also for higher rates that may be as high as 90 vehicles per hour.

By way of example, the various types of a given element correspond to the various models of a given vehicle such as for example a hardtop, a sedan, or a station wagon. In concrete terms, the tailgates of the hardtop type, of the sedan type, or of the station wagon type are not the same for a given model of vehicle.

As orders for vehicles cannot be anticipated, the production line is designed to be completely adaptable so as to be able to adapt to demand throughout the lifetime of the production line for that vehicle. Such a line may also be operated in order to assemble opening members for vehicles of different models, in such a manner as to adapt to demand for the vehicles under consideration, which demand cannot be anticipated either.

The invention aims to provide an arrangement for a sheet metal assembly line that is completely adaptable and that is of low cost.

### SUMMARY OF THE INVENTION

To this end, the invention provides an adaptable installation for assembling sheet metal parts so as to constitute sheet metal elements of a plurality of types, said installation comprising:
a series of assembly stations in a row, each station being dedicated to assembling one type of element;
at least one assembly rail extending parallel to the series of stations in a row and carrying at least one assembly robot that can move from one station to another along the rail that carries it in order to assemble sheet metal parts together at each station; and
at least one handling rail extending along an assembly rail and carrying at least one handling robot in order to supply each station with sheet metal parts and in order to extract the elements that have been assembled from each station, the assembly rail that said handling rail extends along being situated between the handling rail and the series of assembly stations.

The invention also provides an installation as defined above, including two assembly rails extending on either side of the series of stations in a row.

The invention also provides an installation as defined above, including two handling rails extending on either side of the two assembly rails.

The invention also provides an installation as defined above, wherein the assembly robots are spot welding robots.

### BRIEF DESCRIPTION OF THE DRAWINGS

The sole FIGURE illustrates the assembly line of the present invention.

### DETAILED DESCRIPTION OF THE INVENTION

The invention is based on the idea of providing an arrangement comprising a series of assembly stations in a row, together with various rails carrying assembly and handling robots arranged so that the handling robots can move independently of the assembly robots, each of which operates at one of the assembly stations. The handling robots are able to reach all of the assembly stations independently of the assembly robots and vice versa.

The invention achieves this by providing a row of dedicated stations between two rails carrying assembly robots, and by providing handling robots carried by a third rail extending along one of the two rails.

The assembly line that is shown in the sole FIGURE and given reference 1 comprises a series of eight fixed stations given references 2 to 9 that are in a row.

Each of these fixed stations 2 to 9 is arranged for assembling one type of opening member, making it possible to assemble up to eight different types of opening member. In the sole FIGURE, these opening members are shown in the form of identical elements, but in fact they are of different shapes.

The various fixed stations 2 to 9 are in a row along a main direction of the assembly line, given reference AX, which corresponds to an axis extending from the top to the bottom in the sole FIGURE. Two rails given references 11 and 12 are situated on either side of the central row defined by the fixed stations 2 to 9, said two rails 11 and 12 extending parallel to the direction AX, while being situated on either side of the fixed stations.

The rail 11 constitutes an assembly rail, in this example carrying a spot welding robot that is movable along said rail, which enables the robot to move from one of the stations 2 to 9 to another in order to perform spot welding operations at one or another of the stations.

Such a robot comprises a base carrying a base plate that is movable in rotation about a vertical axis and that carries a hinged arm, the base plate being mounted on the rail that carries it in order to be movable in translation along the rail.

The hinged arm presents a bottom portion that is hinged on the base plate in order to be movable in rotation about a horizontal axis, and a top portion that is hinged to the bottom portion that it extends so as to be movable in rotation about an axis that is parallel with the hinge axis between the bottom portion and the base plate.

The top portion of the arm is extended by a head that is movable in rotation relative to the top portion of the arm that it extends, and the assembly is motorized at each of its hinges in order to enable the hinged arm along with its head to place itself in any desired position.

For a spot welding robot, the head is fitted with a welding gun that the robot moves in three dimensions in order to form various series of spot welds located in preprogrammed positions and in a predetermined sequence.

In similar manner, the assembly rail 12 carries two other spot welding robots 14 and 15, of the same type as the robot 13, which robots are movable along the rail 12 in order to be able to operate at each fixed station 2 to 9.

In addition, a third rail 17 extends along the rail 11, while being off-set from the rail 11 that is thus located between the rail 17 and the row of stations 2 to 9.

This third rail constitutes a handling rail, carrying two handling robots 18 and 19. It constitutes an external rail extending along the assembly rail 11, while being positioned in such a way that this assembly rail 11 is situated between the handling rail 17 and the series of fixed stations 2 to 9.

The handling robots are of the same type as the above-described robots: each comprises a base that is movable along the rail that carries it, and carrying a base plate that can swivel about a vertical axis and that carries a hinged arm having two portions, which arm is extended at its top portion by a head that is movable in rotation about various axes.

For a handling robot, the head of the robot is secured to a robot gripper by means of which the robot can handle sheet metal elements and parts. These handling robots 18 and 19 are advantageously fitted with changers enabling them to change the robot gripper so as to be able to handle various sheet metal parts and/or various types of assembled sheet metal element.

For the example shown in the sole FIGURE, the robot given reference 18 ensures the various fixed stations 2 to 9 are provided with sheet metal parts to be assembled. It grips each sheet metal part at a supply station (not shown) that is located at the end of the assembly line, and it places these sheet metal parts on one or another of the assembly stations 2 to 9.

The handling robot 19 extracts each sheet metal element, once it has been assembled, from the fixed station where it was assembled by spot welding performed by the robots 13 to 15, in order to transfer it to another production unit that is not shown in the FIGURE, but that is situated at an end of the line that is opposite from the end where the supply station is located.

As can be seen in the sole FIGURE, by means of the arrangement of the invention, the handling robots 18 and 19, carried by the third rail 17, can supply one station and extract an assembled element from another station, at the same time as the spot welding robots 13 to 15 carried by the rails 11 and 12 weld sheet metal parts at another station in order to assemble another element.

In practice, the welding robots 13 to 15 and the handling robots 18 and 19 can be controlled independently of one another, and that makes it possible to supply one fixed station while the welding robots are finishing assembly of an element at another fixed station.

Thus, by means of the arrangement of the invention, the welding cycle time may be increased since it is no longer penalized by the times required for supply and extraction, which operations can now be performed in parallel with welding operations since the handling robots are independent from the welding robots.

By means of the third rail 17 extending along one of the two rails 11 or 12 that are situated on either side of the row of the fixed stations 2 to 9, the handling robots carried by said third rail 17 can act on the fixed stations 2 to 9 that are at a distance that is still sufficiently close, but without interfering with the spot welding robots that are also intervening on said same fixed stations 2 to 9.

As can be seen in the sole FIGURE, in order to further reduce the possible potential for interference between the various robots, the rail 12, that is the furthest away from the rail 17 carrying the handling robots, carries two welding robots 14 and 15.

In contrast, for the rails 11 and 17 that are adjacent and that extend next to each other, the rail 11 carries a single welding robot 13, and the rail 17 carries two handling robots 18 and 19.

The invention thus makes it possible, as shown diagrammatically in the sole FIGURE, for the supply robot 18 to supply, initially, the fixed station 9 with sheet metal parts that need to be welded to one another in order to assemble a certain type of element, while the welding robots 13 to 15 are in operation welding parts at another station.

Once the welding robots 13 to 15 become available, they are then moved along the rails 11 and 12 in order to position themselves facing the fixed station 9 in order to execute a predetermined cycle of spot welding so as to assemble the element of the type corresponding to said fixed station 9.

While the robots 13 to 15 are executing this welding sequence, the handling robot 18 supplies another fixed station, namely the station No. 2, with sheet metal parts that are to be welded in order to assemble an element of a type corresponding to the fixed station No. 2.

Once the welding cycles are finished at the station No. 9, the welding robots are then moved to the station No. 2 in such a manner as to perform another cycle of spot welding in order to assemble the sheet metal element corresponding to the station No. 2.

While this other welding cycle is being implemented, firstly, the robot 19 extracts the element that has already been assembled at station No. 9 in order to place it on another unit (not shown), and secondly, the supply robot 18 is operated to supply another fixed station, such as for example station No. 6, by placing parts for welding thereon in order to assemble an element of another type

In this example also, once the robots 13 to 15 have finished their spot-welding cycle at the station 2, they are moved to the station No. 6 to start a new cycle. The robot 19 is then operated to extract the assembled element from the station No. 2 so as to take it to another production unit (not shown), after which the robot 18 is operated to supply another station with sheet metal parts in order to assemble a new element.

Each of the fixed stations 2 to 9 may be configured to assemble a particular type of sheet metal element such as an opening member, in such a manner that the assembly line shown in the sole FIGURE thus makes it possible to offer total adaptability over eight different types of element.

In the embodiment described with reference to the FIGURE, the assembly robots secure the sheet metal pieces together by performing spot welding. However, the invention applies equally to a line in which the robots assemble sheet metal parts using adhesive or using any other means for securing one sheet metal part to another, e.g. by crimping.

In addition, the embodiment of the invention that is shown in the sole FIGURE has two assembly rails 11 and 12 situated on either side of the series of fixed stations, together with a handling rail 17 that extends outside the rail 11, but other configurations are possible.

In particular, the invention also relates to a line comprising a single assembly rail extending along a series of fixed stations, and a single handling rail extending along the assembly rail while being situated in such a manner that the assembly rail is positioned between the series of fixed stations and the handling rail.

The invention also relates to an arrangement in which a series of fixed stations are provided that are between two assembly rails on either side, themselves between two outer handling rails.

1. An adaptable installation for assembling sheet metal parts so as to constitute sheet metal elements of a plurality of types, said installation comprising:
a series of assembly stations in a row, each station being dedicated to assembling one type of element;
at least one assembly rail extending parallel to the series of stations in a row and carrying at least one assembly robot that can move from one station to another along the rail that carries it in order to assemble sheet metal parts together at each station; and
at least one handling rail extending along an assembly rail and carrying at least one handling robot in order to supply each station with sheet metal parts and in order to extract the elements that have been assembled from each station, the assembly rail that said handling rail extends along being situated between the handling rail and the series of assembly stations.

2. An installation according to claim 1, including two assembly rails extending on either side of the series of stations in a row.

3. An installation according to claim 2, including two handling rails extending on either side of the two assembly rails.

4. An installation according to claim 1, wherein the assembly robots are spot welding robots.
